(19) United States
(12) Patent Application Publication
(10) Pub. No.: US 2006/0156574 A1
(43) Pub. Date: Jul. 20, 2006

(54) Infra red dryer

(76) Inventors: Christopher P. Parle, Thirsk (GB); David B. Klemz, Ripon (GB)

Correspondence Address: SHERIDAN ROSS PC, 1560 BROADWAY, SUITE 1200, DENVER, CO, 80202, US

(21) Appl. No.: 10/505,292

(22) PCT Filed: Feb. 21, 2003
(86) PCT No.: PCT/GB03/00697

§ 371 Date: Apr. 11, 2005

(30) Foreign Application Priority Data
Feb. 22, 2002 (GB) 0204173.9

(51) Int. Cl. F26B 3/34; F26B 3/00; F26B 13/00

(52) U.S. Cl. 34/266; 34/448; 34/640

(57) ABSTRACT

An IR dryer, for use in drying a continuous paper web by means of IR radiation, comprising an array of IR emitters arranged in use, in spaced relation to the paper web and a lamp protection plate intermediate the IR emitters and the paper web. At least one of the lamp protection plate and the array of IR emitters is curved whereby drying a paper web which moves in a curved path is facilitated.

This invention relates to the field of infra red dryers, in particular short-wave infra red for use in drying paper, board or the like in the papermaking industry.

In the papermaking industry, it is necessary to dry the newly-manufactured paper or board (the “sheet” or “web”) by promoting the evaporation of moisture from the sheet. This is achieved partially by the passing of the sheet over a series of steam-filled drying cylinders and partially by the use of an infra red (“IR”) dryer such as the APOLLO® shortwave IR dryer manufactured by Compact Engineering Ltd of Thirsk, United Kingdom.

Such an IR dryer is typically-placed adjacent the last of the series of drying cylinders and is positioned as close to the moving sheet as possible in order to maximise the drying effect. Drying is achieved by the absorption of IR by the sheet, which causes moisture held by the fibre to evaporate. By careful selection of the wavelength of the IR, excitation of the water molecules can be optimised without creating unnecessary heat which would present a fire risk.

Clearly, the risk of fire is a concern in the papermaking industry, particularly in a situation where the fast-moving sheet breaks or crumples and may come into contact with the IR dryer. In such a case it is essential that the surface of the IR dryer is not hot enough to cause combustion. This risk is addressed by the APOLLO® shortwave IR dryer which has an optical-quality quartz plate intermediate the IR-emitting lamps and the moving sheet. The quartz plate is air-cooled, the air flow not only promotes evaporation of moisture from the sheet but also ensures that the quartz plate does not become hot enough to cause risk of combustion.

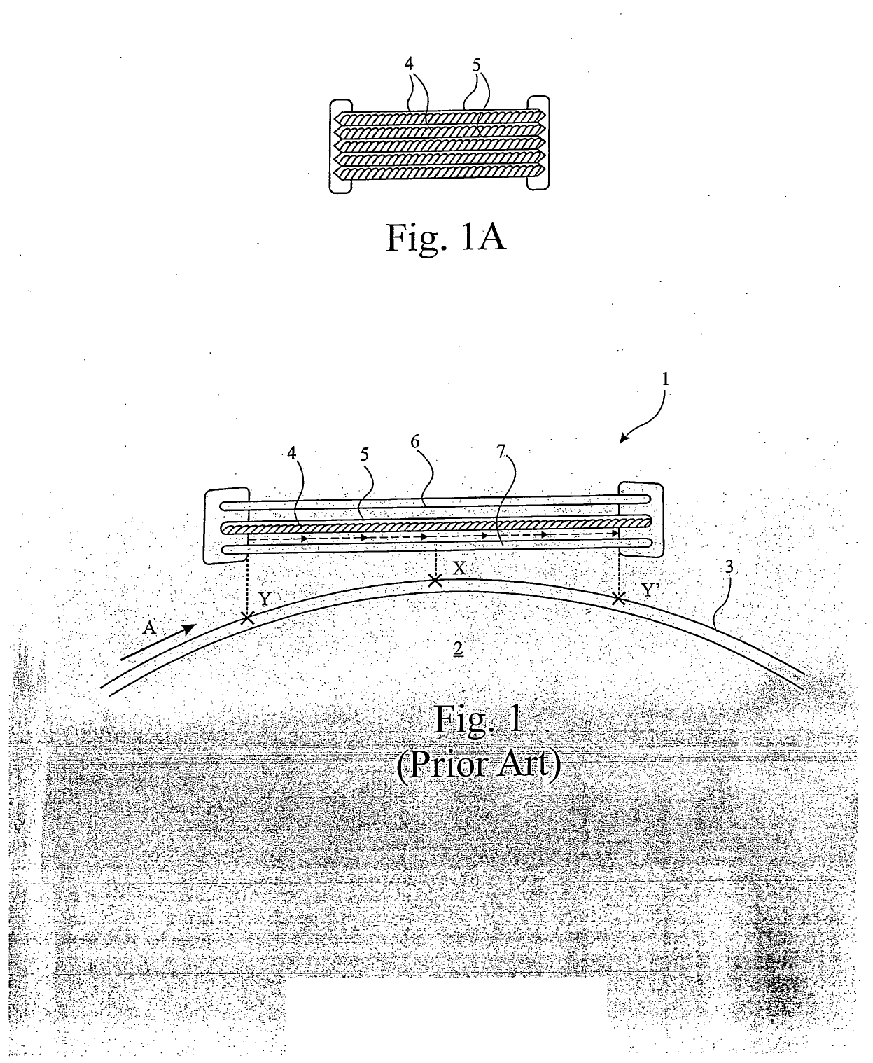

A typical arrangement is shown in FIG. 1 wherein an IR dryer 1 is located adjacent a drying cylinder 2 over which the sheet 3 passes in the direction indicated by arrow A. The IR dryer comprises an array of heating elements 4, each encased in a quartz tube 5, a reflector 6 and a planar quartz plate 7 which protects the lamps (the heating elements encased in quartz tubes) from the moving sheet and from any debris in the vicinity of the apparatus. This plate is known as a “lamp protection plate”. A cooling air flow is provided as indicated by the dotted arrows.

Although very effective, a quartz plate of the type illustrated in FIG. 1 is relatively expensive to manufacture, typically being produced from an opened and flattened cylinder of quartz.

Furthermore, as can be seen in FIG. 1, the IR dryer 1 is not located at a constant distance from the moving sheet, because it has a planar lamp array and quartz plate adjacent the curved surface of the drying cylinder. Optimum drying occurs at point X, with a progressive loss of efficiency between point X, with a progressive loss of efficiency between point X and each of the end point Y, Y′. Towards points Y and Y′, more scattering (reflection) of the IR occurs, rather than the desired absorption which occurs most effectively at point X. This problem has, up to now, been impossible to avoid since all commercially-available IR dryers have this planer arrangement.

It is thus an object of the present invention to provide an IR dryer which seeks to alleviate the above-mentioned problems.

According to a first aspect of the invention there is provided an IR dryer, for use in drying a continuous paper web by means of IR radiation, comprising
an array of IR emitters arranged, in use, in spaced relation to the paper web;
a lamp protection plate intermediate the IR emitters and the paper web,
characterised in that at least one of the lamp protection plate and the array of IR emitters is curved whereby drying a paper web which moves in a curved path is facilitated.

The provision of a curved array of IR emitters and/or lamp protection plate mitigates the problem illustrated in and described with reference to FIG. 1 above. The curvature of the IR emitters and/or lamp protection plate ideally closely matches the curvature of the drying cylinder over which the paper web is moving, so that the drying effect is even and optimised.

Provision of curved IR emitters and/or a curved lamp protection plate has, up to now, not been commercially feasible because the technical problems and expense associated with providing curved lamps/plate of sufficient quality were prohibitive. The method described below enables the curved lamps/plate to be produced so that the first aspect of the invention can be put into effect.

Preferably each of said IR emitters is a lamp comprising a heating element located within a curved quartz tube. Alternatively, each of said IR emitters is gas powered.

Preferably, said lamp protection plate comprises an array of curved quartz tubes. This means that quartz tubes, identical to those used in the IR-emitting lamps, can also be used to form the lamp protection plate, thus reducing expense as only one type of tube needs to be produced. Furthermore, in any case, the use of curved quartz tubes (manufactured according to the method described below) is much more cost-effective than conventional production methods for known quartz lamp protection plates.

Ideally, said lamp protection plate is cooled, in use, by the passage of gas, for example air, through said curved quartz tubes. The use of quartz tubes to form the lamp protection plate provides useful paths (i.e. the interior of the tubes) through which air can be passed to cool the lamp protection plate, which would not be possible with a conventional lamp protection plate made from a solid plate of quartz.

Preferably, the IR dryer further comprises a curved reflector plate.

According to a second aspect of the invention there is provided an IR dryer, for use in drying continuous paper web by means of IR radiation, comprising
an array of IR emitters arranged, in use, in spaced relation to the paper web,
a lamp protection plate intermediate the IR emitters and the paper web,
characterised in that the lamp protection plate comprises a plurality of quartz tubes arranged in an array.

Preferably, the lamp protection plate is cooled in use, by the passage of gas, for example air, through said quartz tubes.

Preferably, said IR emitters are lamps each comprising a quartz tube, substantially identical to those used in the lamp protection plate, in which is located an IR heating element.

Preferably, said quartz tubes are curved.

Use of quartz tubes, identical to those used in the IR-emitting lamps, to form the lamp protection plate, reduces expense as only one type of tube needs to be produced. Furthermore, in any case, the use of either readily-available (linear) quartz tubes, or curved quartz tubes (manufactured according to the method described below) is much more cost-effective than conventional production methods for known quartz lamp protection plates.

According to a third aspect of the invention there is provided a method of bending an elongate quartz tube comprising the steps of
supporting the tube in a substantially vertical orientation;
gripping the tube near its uppermost end;
heating the tube at region intermediate its lowermost end and the uppermost end; and
moving the gripped uppermost end of the tube so that the tube softened in the vicinity of the heating region, is bent.

It is essential that the moving force is applied to the tube by gripping and pulling near its uppermost end rather than from below the tube. In contrast to metal, the “softening point” of glass, i.e. the temperature to which the glass needs to be heated in order to deform, is relatively near the melting point of glass. The fragility of glass and the nearness of its softening point to its melting point means that a glass tube could not withstand a pushing force applied from below without “slumping” or collapsing. It is therefore necessary to provide the moving force from above, i.e. by pulling at the uppermost end of the tube.

Preferably, the gripped uppermost end of the tube is moved in an arc.

Preferably, the tube is counterbalanced.

Preferably, the lowermost end of the tube is constrained to move in a substantially vertical path.

According to a fourth aspect of the invention, there is provided apparatus for bending an elongate quartz tube comprising
support means for supporting the tube in a substantially vertical orientation;
gripping means for gripping the tube near its uppermost end;
heating means situated at region intermediate the lowest and the uppermost end of the tube and
driving means for moving the gripped uppermost end of the tube in use, so that the tube softened in the vicinity of the heating means, is bent.

Preferably, the heating means substantially surrounds the tube, in use.

Preferably, the heating means comprises a plurality of gas burners. Ideally the plurality of gas burners comprises a ring of gas burners, in the centre of which the tube is situated, in use.

In a preferred form, the apparatus is provided with barrier means which has a curved surface against which the tube may abut, in use, so as to prevent lateral movement of the tube. Advantageously, the barrier means comprises a wheel. Ideally, the wheel is removeable and replaceable with a wheel of different diameter.

Preferably, the apparatus further comprises a counter-balance arrangement by means of which the lowermost end of the tube can be constrained, in use, to follow a substantially vertical path.

In a preferred form, said driving means comprises a pivotable arm, at one end of which is situated said gripping means, the arm being pivotable, in use, so that the gripping means generally describes an arc. Ideally, said pivotable arm is driven by a motor.

Preferably, the pivot point of said pivotable arm is, in use, substantially horizontally level with a desired region of bending of the tube.

Preferably, said gripping means is water-cooled.

According to a fifth aspect of the invention, there is provided a curved quartz tube manufacture using the apparatus and/or method of any of the preceding paragraphs. Preferably, an infra red (IR) heating element is located within the curved quartz tube.

According to a sixth aspect of the invention there is provided an IR dryer for use in the papermaking industry which includes an array of curved lamps each of which lamps comprises a heating element located within a curved quartz tube as claimed in the preceding paragraph. Ideally, the dryer further includes a curved reflector plate.

According to a seventh aspect of the invention there is provided an IR dryer for use in the papermaking industry including a curved lamp protection plate which comprises an array of curved quartz tubes as described above.

Preferred embodiments of the present invention will now be more particularly described, by way of example only, with reference to the accompanying drawings wherein,

FIG. 1 is a cross-sectional view of a known type of IR dryer adjacent a drying cylinder (PRIOR ART);

FIG. 1A is a schematic top view of the array of quartz tubes (PRIOR ART);

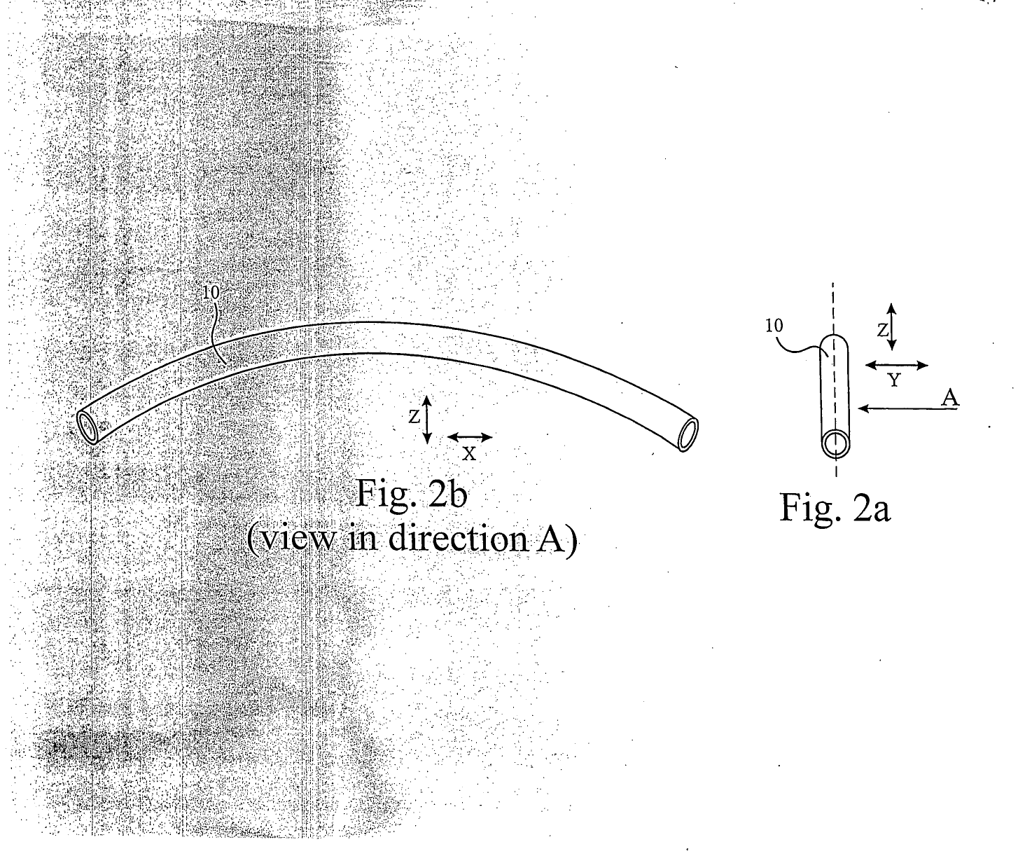

FIG. 2A is an end view of a curved quartz tube according to one aspect of the invention;

FIG. 2B is a side view (on arrow A) of the tube shown in FIG. 2A;

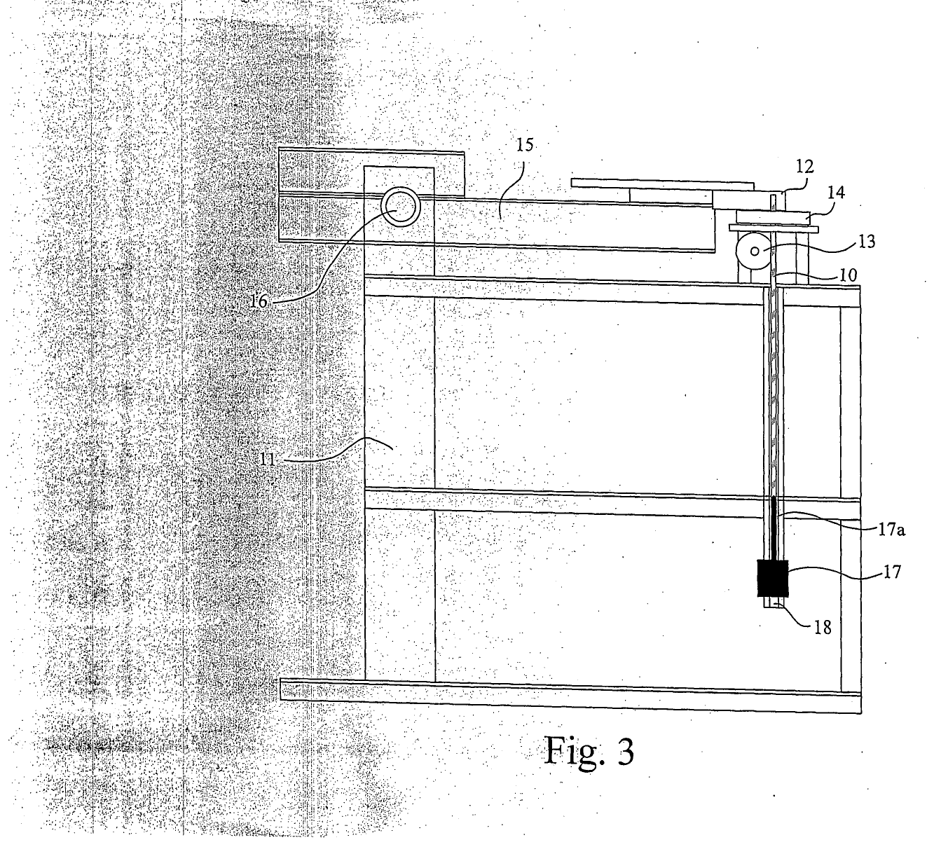

FIG. 3 is a schematic side view of apparatus for bending a quartz tube, with a quartz tube in place ready to be bent;

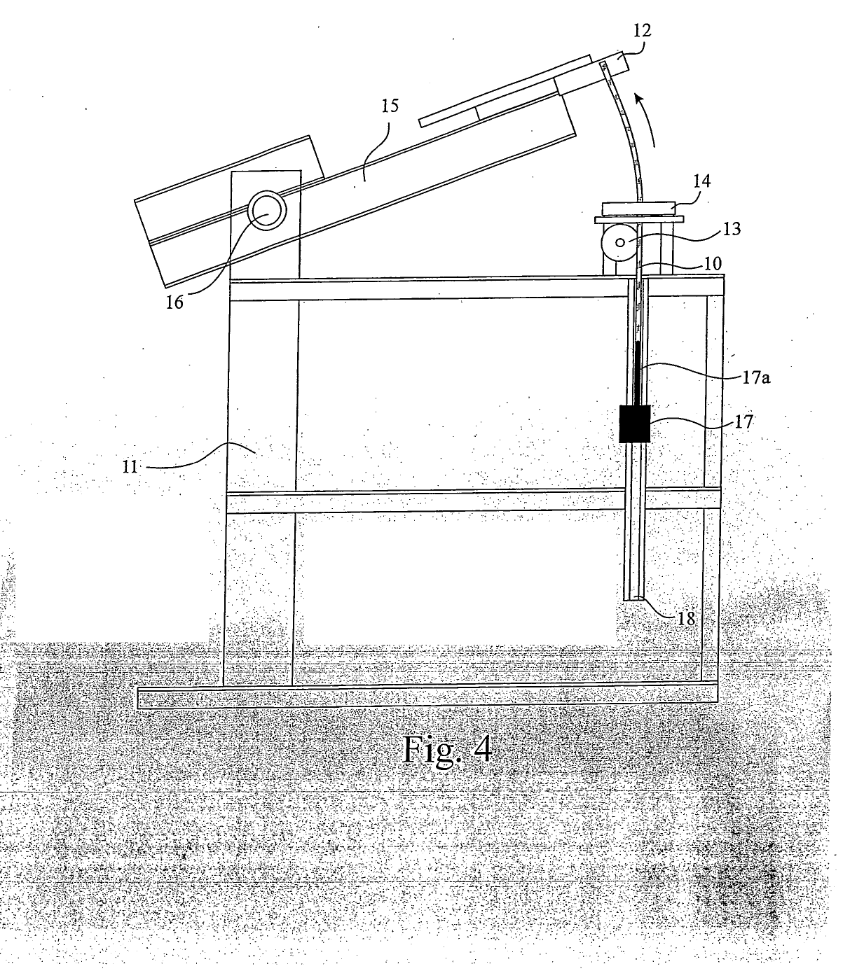

FIG. 4, drawn to a smaller scale, shows the apparatus of FIG. 3 part-way through the bending process;

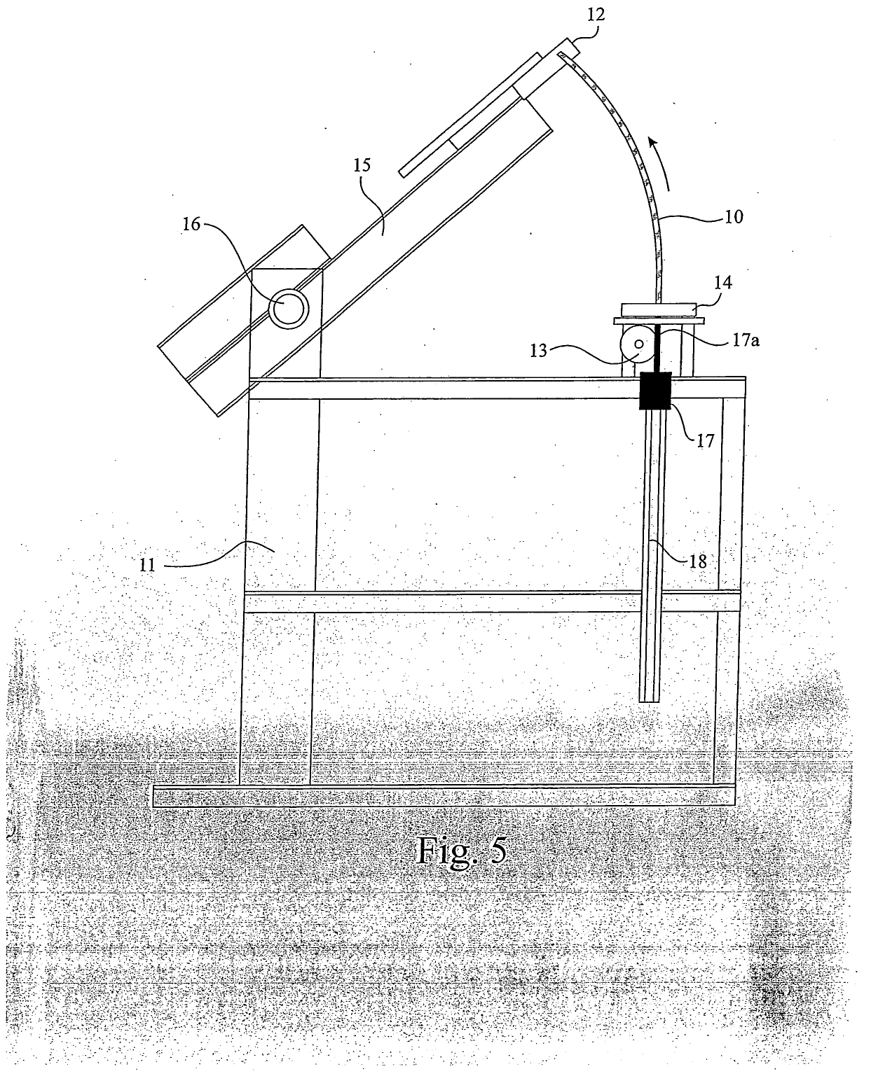

FIG. 5 shows the apparatus of FIG. 4 at the end of the bending process;

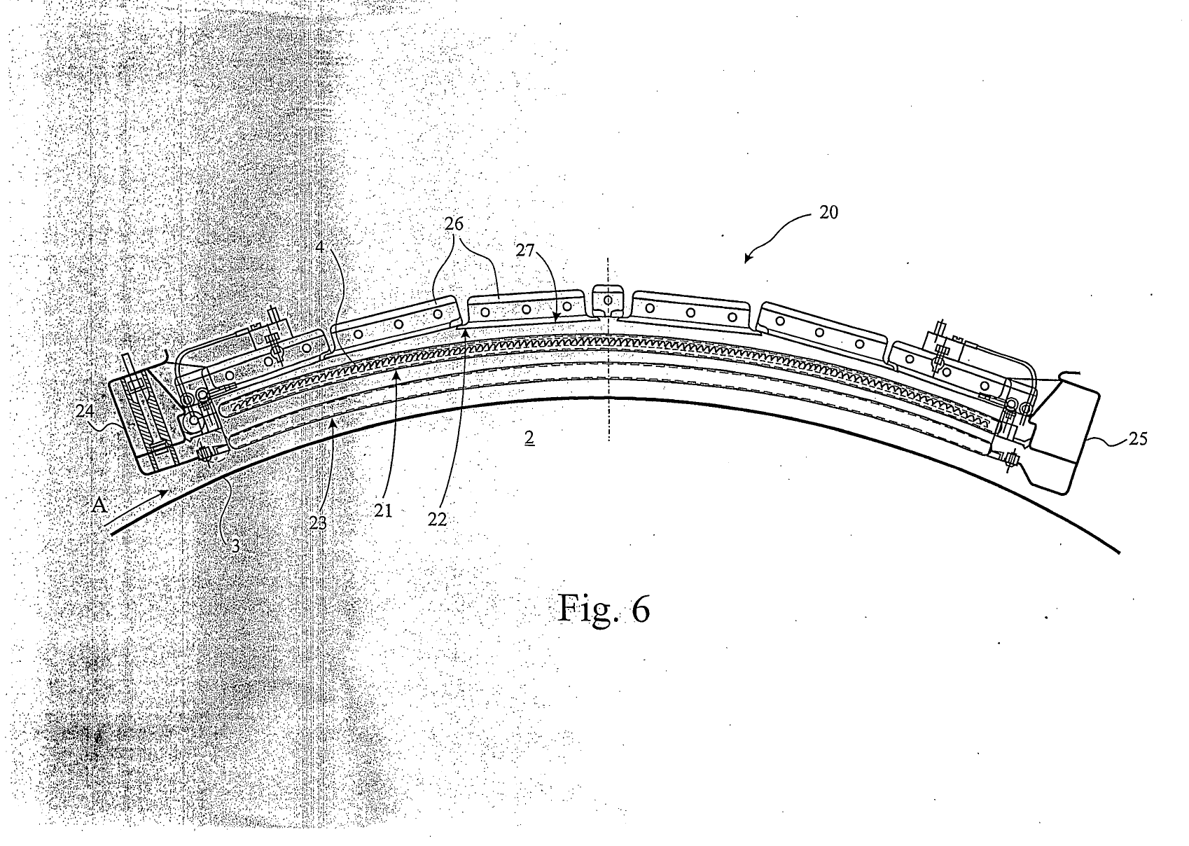

FIG. 6 is a cross-sectional view of an IR dryer incorporating curved quartz tubes;

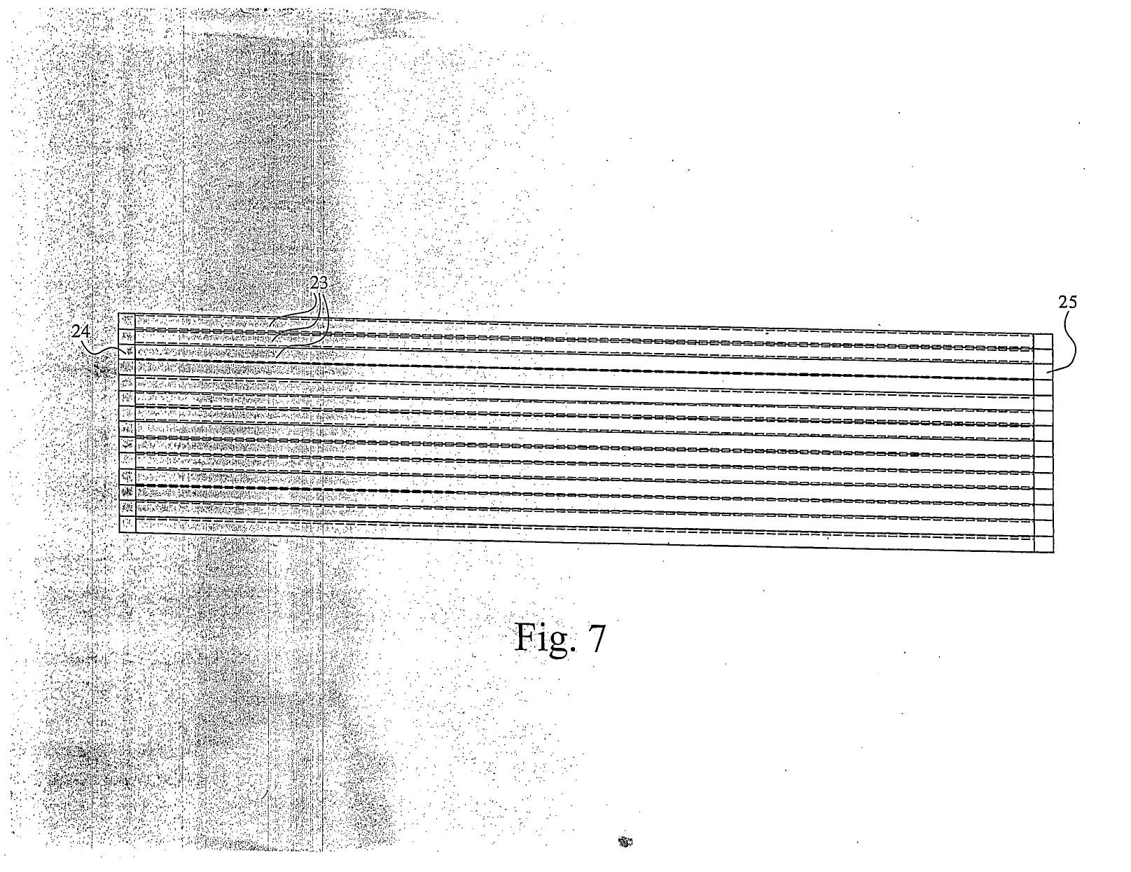

FIG. 7 is a schematic plan view, drawn to a larger scale, of the array of quartz tubes comprising the lamp protection plate illustrated in FIG. 6;

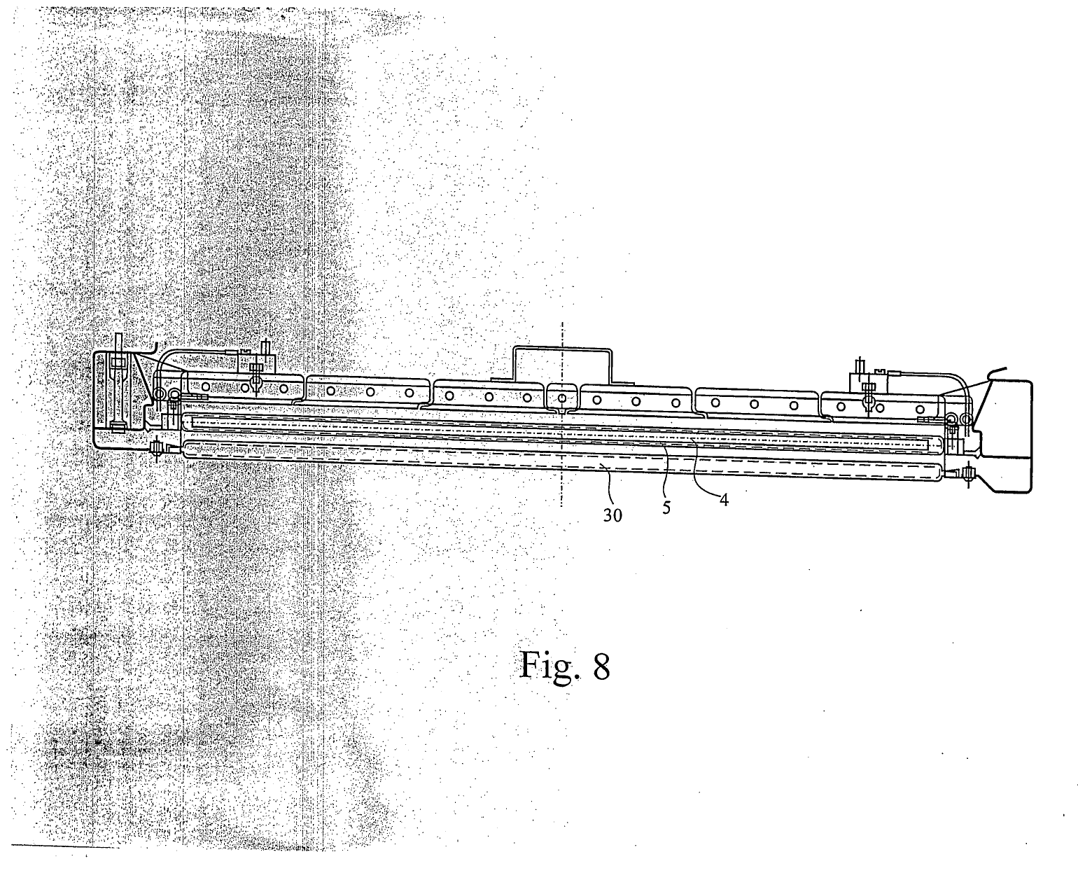

FIG. 8 is a cross-sectional view of part of an electrically-powered IR dryer incorporating a lamp protection plate comprising linear quartz tubes; and

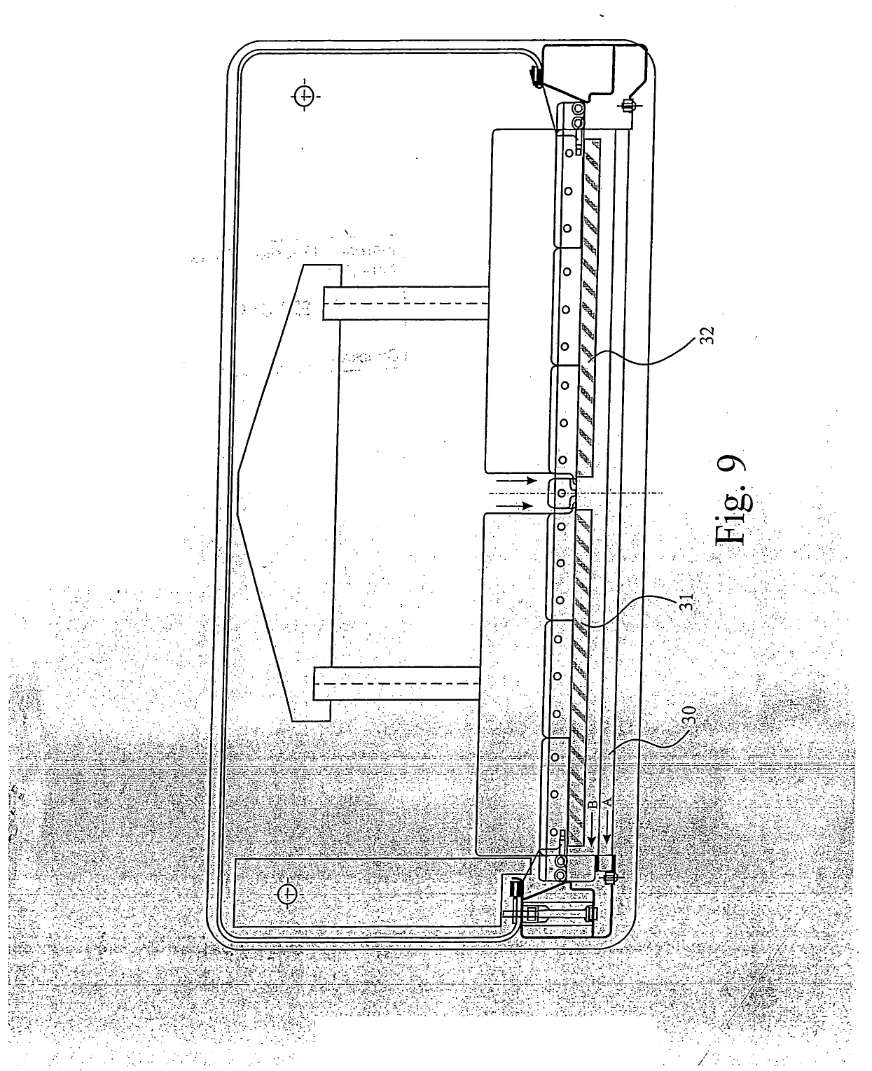

FIG. 9 is a cross-sectional view of part of a gas-powered IR dryer incorporating a lamp protection plate comprising linear quartz tubes.

Throughout this application, the term “quartz” is used to refer to vitreous silica or quartz glass. The term “array” in the context of quartz tubes or heating elements means that a plurality of elongate tubes and/or heating elements are arranged side by side, with their longitudinal axes parallel to one another (see FIG. 1A, for example). Although reference is made throughout this application to an electrically-powered IR dryer, the invention is equally applicable to a gas powered IR dryer.

Quartz tubes are commonly known in the field of IR paper drying. Such tubes are linear elongate, hollow, quartz tubes each of which are used to accommodate IR heating element. A plurality of such tubes containing heating elements (“lamps”) are arranged side-to-side to create the array of IR lamps illustrated in FIGS. 1 and 1A and known as prior art. In this arrangement it is important that the quartz tubes are very straight so that they can be located closely adjacent one another without creating gaps therebetween and so that the array of tubes is substantially flat.

In contrast, the first aspect of the present invention relates to a process for bending quartz tubes to create a curved tube of the type shown in FIG. 2. The curved tube 10 is bent in one plane only, i.e. so that it is still very straight in directions X and Y (as shown in FIGS. 2A and 2B) but is curved in direction Z.

The quartz tubes are those commonly known in the field of IR dryers for the paper making industry such as are normally used to enclose an IR heating element. The quartz tubes are bent using apparatus as illustrated in FIGS. 3-5.

Referring to FIG. 3, the apparatus comprises a floor-standing frame support 11, in which can be supported a quartz tubes 10. The quartz tube 10 is held in a substantially vertical position and is gripped at its upper end by gripping means 12. The gripping means 12 may be water-cooled when the apparatus is in use.

A guide wheel 13 provides a barrier means for the quartz tube 10. The guide wheel 13 is mounted as illustrated in FIG. 3 so that the quartz tube when hanging from the gripping means 12 is near an edge of the guide wheel 13. When the apparatus is in use, the guide wheel 13 prevents lateral movement of the quartz tube as described in more detail below. The guide wheel may be removeable and replaceable with a wheel of different diameter.

Intermediate the guide wheel (“the barrier means”) and the gripping means is a ring burner 14 which surrounds the quartz tube 10. The ring burner is preferably a gas-powered ring burner, but other suitable means for localised heating of the quartz tube may be envisaged. It is important to note that ring burner 14 (“the heating means”) is situated between the guide wheel and the gripping means.

The gripping means 12 is mounted at the distal end of a pivotable arm 15 which is pivotable about a pivot point 16. The pivoting of the arm 15 is controlled by a driving means (not shown) which may be, for example, an electric motor. The pivot point 16 of the pivotable arm 15 is, in use, substantially horizontally level with a desired region of bending of the tube.

Alignment of the quartz tube during bending may be effected-using a counterbalanced arrangement comprising a glass follower 17 which runs in a track 18. The follower 17 includes an upstanding spigot 17A which is of suitable diameter to fit within the lowermost end of the hollow quartz tube. The follower 17 is slidably mounted in track or guide rail 18 so that the lowermost end (by means of the spigot 17A and track-mounted follower 17) is contained to move only vertically i.e. along track 18. The mass of follower 17 and spigot 17A is such that it counterbalances the mass of the quartz tube 10. Alternatively, a geared mechanism could be used to achieve this effect.

With reference to FIGS. 4 and 5, the apparatus is used as follows. The ring burner 14 is ignited so as to heat the region of the quartz tube enclosed by the burner. This causes the quartz tube to heat up and soften in that particular region.

The driving means (not shown) causes the pivotable arm 15 to pivot about point 16 in the direction indicated by the arrow in FIG. 4. The pivoting is controlled and relatively slow, the speed being determined according to the dimensions and type of quartz tube being bent and may take into account other factors such as the temperature of the heating means etc. The pivoting of the arm 15 causes the gripping means 12 to describe an arc, pulling the gripped uppermost end of the quartz tube 10 with it, so as to bend the tube. Undesirable lateral movement of the quartz tube (i.e. toward the pivot point 16) is prevented by abutment of the tube (lower down) against the guide wheel 13. Such undesirable lateral movement may occur if the quartz tube has greater diameter than expected or if the tube is not hot enough to bend properly in the vicinity of the heating means.

As the gripped uppermost end of the quartz tube is being moved by the pivotable arm, the whole quartz tube is moving vertically. The glass follower 17 (and hence the lowermost end of the quartz tube) is constrained to move vertically within the track 18 so that the straightness of the quartz tube in two of the three dimensions is maintained. Thus the tube is only bent in one desired dimension.

In fact, this method can also be used to improve the straightness of the tube in the said two of the three dimensions. It is known that, when conventional linear quartz tubes are manufactured, slight undesirable curvature may occur as a result of the manufacturing process. This is undesirable when the linear tubes are to be used in a (conventional) linear array of IR emitters because it means that linear tubes may not sit tightly side-by-side.

However, it is particularly undesirable when the tubes are intended to be used in the formation of a lamp protection plate (either planar or curved, according to the relevant embodiments of the present invention) because any gaps between the array of tubes arranged side-by-side may allow debris to pass through the lamp protection plate potentially causing damage to the IR dryer.

It is therefore highly desirable to correct any curvature manufacturing defects in the linear tubes used in the method described herein. This occurs automatically in the bending process described above. It is also envisaged that the bending apparatus described herein could be adapted to correct curvature defects in a linear quartz tube, without bending, by “drawing” the tube vertically upwards from a gripped portion near its uppermost end. The track/follower arrangement described above could be used without significant adaption in this case.

FIG. 5 illustrates the apparatus at the end of the bending process. The quartz tube 19 has been moved to its maximum vertical extent (for example limited by the spigot 17A reaching the frame 11) and the quartz tube is now curved, having been bent along its entire length. Key radius between the pivot point 16 and the ring burner 14, and the diameter (and hence mass) of the quartz tube which needs to be softened.

Once sufficiently cooled, the curved quartz tube can be removed from the apparatus and should resemble that illustrated in FIG. 2.

Two novel uses for the curved quartz tube are illustrated in FIG. 6, although both need not necessarily be used within the same IR drying apparatus. FIG. 6 is a cross-sectional view of IR drying apparatus for use in the paper-making industry. As with FIG. 1, a drying cylinder 2 is illustrated, over which a paper web 3 moves in the direction indicated by the arrow A.

The IR dryer 20 comprises an array 21 of heating elements 4, each encased in a curved quartz tube 10 to form a “lamp”, a curved reflector 22 and a curved quartz plate 23 which protects the lamps from the moving sheet and from any debris in the vicinity of the apparatus.

Unlike the prior art illustrated in FIG. 1, the curved quartz plate 23 is not made from a single piece of flattened quartz. An array of curved quartz tubes 10 can be used, in side-to-side arrangement to form a “plate” (better referred to as a “curved lamp protection plate”). Since the quartz tubes are bent with such accuracy, using the above described method, they can be closely aligned, side-by-side to form the lamp protector plate with their ends held firmly within side plates 24, 25. The array of tubes is shown schematically in plan view in FIG. 7.

The curved reflector 22 comprises a plurality of linear reflector units 26 linked together, which are preferably gold-coated to provide a good reflective surface 27 for reflecting IR from the lamps.

Given the curved nature of the lamps and the lamp protection plate, the IR dryer 20 is located at a substantially constant distance from the moving paper web 3, because the lamp array and lamp protection plate follow the curved surface of the drying cylinder. Optimum drying occurs across the full width of the IR dryer.

Although the description above relates to the provision of curved quartz tubes, the use of quartz tubes to make a planar lamp protection plate is also new and advantageous. FIG. 8 is a cross-sectional view of part of an electrically-powered IR dryer incorporating a lamp protection plate comprising linear quartz tubes.

As in FIG. 1, the heating elements 4 are each encased in a linear quartz tube 5, as is commonly known. These linear quartz tubes are readily available. A plurality of linear quartz tubes can be placed together in side-by-side relation to form an array which is used as a lamp protection plate 30, as illustrated in FIG. 8. A lamp protection plate 30, made from linear quartz tubes is much more cost-effective than the known type of lamp protection plate comprising a solid quartz plate. Use of quartz tubes also has the advantage of allowing air or other cooling fluid to be passed through the hollow tubes, when the IR dryer is in use, to cool the lamp protection plate. This of course is not possible using a conventional (solid) lamp protection plate.

Use of linear quartz tubes to form a lamp protection plate 30 is equally applicable to a gas-powered IR dryer and this is illustrated in FIG. 9. Cooling air can be passed through the tubes in the direction indicated by arrow A, for example. Passage of cooling air through the tubes (A) may be instead of or in addition to cooling air being passed (conventionally) between the lamp protection plate and the gas-powered IR emitters 31, 32. However, it may be particularly advantageous to run cooling air through the tubes (A) instead of conventionally (B) so as not to interfere with the gas flames providing the heat source.

The method of bending quartz tubes as described herein thus offers the possibility of improving the drying capability of an IR dryer by allowing the lamps to be situated at a constant, optimum distance from a drying cylinder, radiating normal to the surface of the cylinder.

Furthermore, the cost of manufacturing IR drying apparatus can be significantly reduced by using an array of curved quartz tubes, either linear or bent as described herein, in place of the conventional flattened quartz plate used as a lamp protection plate.

1. An IR dryer, for use in drying a continuous paper web by means of IR radiation, comprising
an array of IR emitters arranged, in use, in spaced relation to the paper web;
a lamp protection plate intermediate the IR emitters and the paper web;
characterized in that at least one of the lamp protection plate and the array of IR emitters is curved whereby drying a paper web which moves in a curved path is facilitated.

2. An IR dryer as claimed in claim 1 wherein each of said IR emitters is a lamp comprising a heating element located within a curved quartz tube.

3. An IR dryer as claimed in claim 1 wherein each of said IR emitters is gas-powered.

4. An IR dryer as claimed in claim 1 wherein said lamp protection plate comprises an array of curved quartz tubes.

5. An IR dryer as claimed in claim 4 wherein said lamp protection plate is cooled, in use, by the passage of gas through said curved quartz tubes.

6. An IR dryer as claimed in claim 1 further comprising a curved reflector plate.

7. An IR dryer, for use in drying a continuous paper web by means of IR radiation, comprising
an array of IR emitters arranged, in use, in spaced relation to the paper web;
a lamp protection plate intermediate the IR emitters and the paper web;
characterized in that the lamp protection plate comprises a plurality of quartz tubes arranged in an array.

8. An IR dryer as claimed in claim 7 wherein the lamp protection plate is cooled in use, by the passage of gas through said quartz tubes.

9. An IR dryer as claimed in claim 7 wherein said IR emitters are lamps, each comprising a quartz tube, substantially identical to those used in the lamp protection plate, in which is located in an IR heating element.

10. An IR dryer as claimed in claim 7 wherein said quartz tubes are curved.

11. A method of bending an elongate quartz tube comprising the steps of;
supporting the tube in a substantially vertical orientation;
gripping the tube near its uppermost end;
heating the tube at region intermediate its lowermost end and the uppermost end; and
moving the gripped uppermost end of the tube so that the tube, softened in the vicinity of the heating region, is bent.

12. A method as claimed in claim 11 wherein the gripped uppermost end of the tube is moved in an arc.

13. A method as claimed in claim 11 wherein the tube is counterbalanced.

14. A method as claimed in claim 11 wherein the lowermost end of the tube is constrained to move in a substantially vertical path.

15. Apparatus for bending an elongate quartz tube comprising
support means for supporting the tube in a substantially vertical orientation;
gripping means for gripping the tube near its uppermost end;
heating means situated at a region intermediate the lowermost end and the uppermost end of the tube; and
driving means for moving the gripped uppermost end of the tube, in use, so that the tube, softened in the vicinity of the heating means, is bent.

16. Apparatus as claimed in claim 15 wherein the heating means substantially surrounds the tube, in use.

17. Apparatus as claimed in claim 15 wherein the heating means comprises a plurality of gas burners.

18. Apparatus as claimed in claim 17 wherein the plurality of gas burners comprises a ring of gas burners, in the center of which the tube is situated, in use.

19. Apparatus as claimed in claim 15 further comprising barrier means which has a curved surface against which the tube may abut, in use, so as to prevent lateral movement of the tube.

20. Apparatus as claimed in claim 19 wherein the barrier means comprises a wheel.

21. Apparatus as claimed in claim 20 wherein the wheel is removable and replaceable with a wheel of different diameter.

22. Apparatus as claimed in claim 15 further comprising a counter-balance arrangement by means of which the lowermost end of the tube can be constrained in use, to follow a substantially vertical path.

23. Apparatus as claimed in claim 15 wherein said driving means comprises a pivotable arm, at one end of which is situated said gripping means, the arm being pivotable, in use, so that the gripping means generally describes an arc.

24. Apparatus as claimed in claim 23 wherein a pivot point of said pivotable arm is, in use, substantially horizontally level with a desired region of bending of the tube.

25. Apparatus as claimed in claim 23 wherein said pivotable arm is driven by a motor.

26. Apparatus as claimed in claim 15 wherein said gripping means is water-cooled.

27. (canceled)

28. (canceled)

29. An IR dryer for use in the papermaking industry comprising:
an array of curved lamps, each of which lamps includes an IR heating element located within a curved quartz tube.

30. An IR dryer as claimed in claim 29 further including a curved reflector plate.

31. An IR dryer for use in the papermaking industry comprising:
a curved lamp protection plate which includes an array of curved quartz tubes.
